(19) United States
(12) Patent Application Publication
(10) Pub. No.: US 2007/0014442 A1
(43) Pub. Date: Jan. 18, 2007

(54) Processing apparatus for controlling execution of processing based on user's fingerprint information and control method therefor

(75) Inventor: Kazutoshi Yu, Kobe-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/436,560

(22) Filed: May 19, 2006

(30) Foreign Application Priority Data
Jul. 8, 2005 (JP) 2005-200285

(51) Int. Cl. G06K 9/00

(52) U.S. Cl. 382/124; 340/5.83; 713/182

(57) ABSTRACT

A processing apparatus capable of improving the degree of security protection without requiring a user to perform any additional operations, the processing apparatus determining whether or not a logged-in user is the same person as a user who pressed input confirmation button to confirm contents of input information by comparing first fingerprint information obtained when the user logged in and second fingerprint information obtained when the input confirmation button was pressed, and carrying out processing based on the contents of the input and confirmed information if the user's identity is confirmed.

This application is based on Japanese Patent Application No. 2005-200285 filed in Japan on Jul. 8, 2005, the entire content of which is hereby incorporated by reference.

### BACKGROUND OF THE INVENTION

1. Field of the Invention

The present invention relates to a processing apparatus that executes processing in accordance with instructions provided by the user, as well as to a control method therefor.

2. Description of the Related Art

An image processing apparatuses termed an MFP (Multifunction Peripherals) that includes the functions of a copying machine, network printer, scanner, fax and document server has become widely used in recent years.

The increasing number of different functions possessed by this type of image processing apparatus has led to its being shared by a number of users, which has created demand for security measures or management of the charging of fees for the use thereof. Consequently, users of such an image processing apparatus are sometimes required to perform user authentication. This prevents the unauthorized use of the image processing apparatus and enables the status of use thereof to be tracked for each user.

There are three main methods of user authentication: Memory-based authentication, ownership authentication and biometric authentication. In the memory-based authentication method, a user seeking user authentication enters into the image processing apparatus via keyboard a user ID and password that are known only to the user. In the ownership authentication method, the user carries a storage medium such as a USB token or IC card on which key information issued only to the user is stored, and the user when seeking user authentication places the storage medium in the image processing apparatus for reading of this key information. In the biometric authentication method, a user seeking user authentication has the image processing apparatus read a unique physical characteristic of the user such as his fingerprint or iris. The image processing apparatus performs user authentication using the information input or read via the above methods. Recently, increased attention has been paid to the biometric authentication method, which does not require the user to memorize a password or carry a storage medium.

Japanese Laid-Open Patent Applications 2002-44313 and 2002-108487 disclose image processing apparatuses that use fingerprint-based authentication. According to the image processing apparatus of Japanese Laid-Open Patent Application 2002-44313, information regarding an operation regularly executed by each individual is registered in advance in association with the person's fingerprint information. As a result, even if such operation comprises the configuration of a complex image processing function, the user can execute it via a simple one-touch operation.

According to the image processing apparatus described in Japanese Laid-Open Patent Application 2002-108487, the user's fingerprint information and password are registered in advance, and when fingerprint-based authentication fails, the user logs in using the password.

However, when using the conventional art methods disclosed in these patent documents, if an authenticated user leaves the image processing apparatus while it is running, an unauthorized user could then use it without the user's permission. This is undesirable from a security standpoint, and entails the possibility of the user incurring erroneous charges.

Accordingly, a method is often used in which the user is logged out automatically when the image processing apparatus is not operated for a preset period of time. However, in this method, where the preset period is long, the degree of security obtained is minimal. Where the preset length of time is short, on the other hand, the user may often be logged out involuntarily. If that happens, the user must repeat the login operation and occasionally reproduce his entire work from the beginning, which is burdensome.

While a system can be employed in which the user logs out manually each time he leaves the image processing apparatus, he must then log in upon his return to the image processing apparatus to resume work. This method as well is therefore burdensome for the user. In addition, the user may forget to log out before leaving the image processing apparatus.

In addition to image processing apparatuses such as MFPs, other types of processing apparatuses shared by multiple users, such as personal computers and workstations, also entail the above problems.

### Object and Summary

An object of the present invention is to provide an improved processing apparatus and control method therefor that resolve the various problems identified above.

Another object of the present invention is to improve the degree of security protection for a processing apparatus without requiring the user to perform any additional operations.

These and other objects are attained by providing a processing apparatus having the configuration described below:

an input button used to input information;

an input confirmation button used to confirm the contents of said input information;

a first obtaining unit that obtains at the time of the user's login to said processing apparatus first fingerprint information comprising information regarding the user's fingerprint;

a storage device that stores said first fingerprint information obtained by said first obtaining unit;

a second obtaining unit that obtains second fingerprint information comprising information regarding the fingerprint of the finger used to press said input confirmation button;

a determination unit that, after the user has logged into said processing apparatus, determines whether or not the user who pressed said input confirmation button to confirm the contents of said input information is identical to the user who logged into said processing apparatus, by comparing (i) said second fingerprint information obtained by said second obtaining unit when said input confirmation button was pressed in order to confirm the contents of said information input via said input button and (ii) said first fingerprint information stored in said storage device; and

a controller that, when the user's identity is confirmed by said determination unit, executes control of the various components of said processing apparatus to carry out processing based on the contents of said input and confirmed information.

### BRIEF DESCRIPTION OF THE DRAWINGS

These and other objects and features of the present invention will become clear from the following description taken in conjunction with the preferred embodiments thereof with reference to the accompanying drawings, in which:

FIG. 1 is a drawing showing an example of the configuration of a system using an image forming apparatus;

FIG. 2 is a drawing showing an example of the hardware configuration of the image forming apparatus;

FIG. 3 is a drawing showing an example of the configuration of an operation panel;

FIG. 4 is an explanatory drawing showing an example of the hardware configuration of a fingerprint reader and an example of the sequence of operations performed during fingerprint reading;

FIG. 5 is a drawing showing an example of the functional configuration of the image forming apparatus;

FIG. 6 is a drawing showing an example of a user information table;

FIG. 7 is a drawing showing an example of a login screen;

FIG. 8 is a flow chart regarding the sequence of operations of the overall operation of the image forming apparatus; and

FIG. 9 is a flow chart showing the sequence of operations performed when identities do not match.

### DETAILED DESCRIPTION OF THE PREFERRED EMBODIMENTS

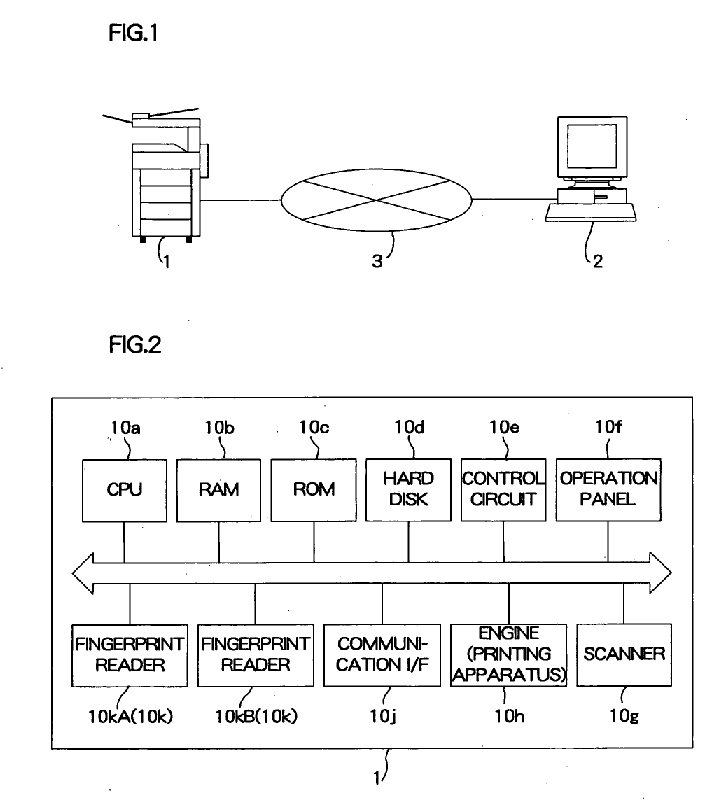

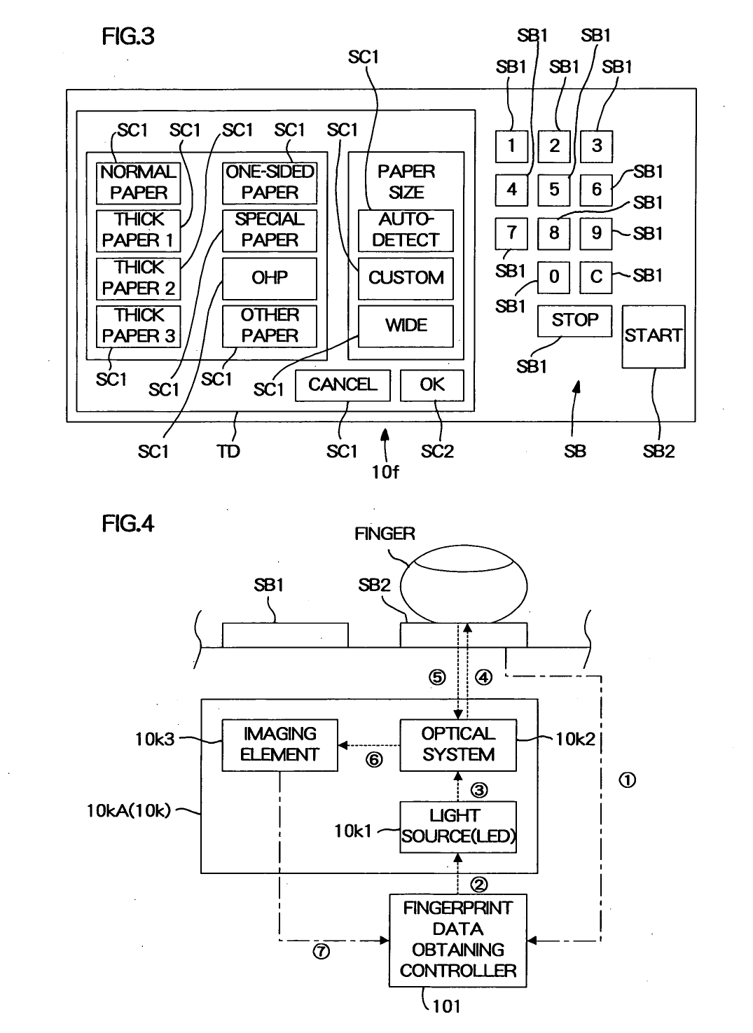

FIG. 1 is a drawing showing an example of the configuration of a system using an image forming apparatus 1. FIG. 2 is a drawing showing an example of the hardware configuration of the image forming apparatus 1. FIG. 3 is a drawing showing an example of the configuration of an operation panel 10f. FIG. 4 is a drawing to describe an example of the hardware configuration of a fingerprint reader 10k and an example of the sequence of operations performed during fingerprint reading.

The image forming apparatus 1 is connected to a terminal device 2 over a communication circuit 3 as shown in FIG. 1. The Internet, an intranet, public circuits or dedicated lines are used for the communication circuit 3.

An application program and a driver that serve the image forming apparatus 1 are installed in the terminal device 2. The terminal device 2 may comprise a personal computer, workstation or PDA (Personal Digital Assistant).

The image forming apparatus 1 is a processing apparatus that possesses various functions, including the functions of a copying machine, scanner, fax, network printer and document server. It is sometimes called an MFP. The ‘network printer’ function is a function by which image data is received from the terminal device 2 and an image is printed on paper. It may be called a ‘network printer function’ or ‘PC print function’. The ‘document server’ function is a function where a storage area termed a ‘box’ or ‘personal box’ and equivalent to a folder or directory in a personal computer is provided to each user to enable the user to save document data such as an image file in the storage area. This function is sometimes referred to as a ‘box function’.

As shown in FIG. 2, the image forming apparatus 1 comprises a CPU 10a, a RAM 10b, a ROM 10c, a hard disk 10d, a control circuit 10e, an operation panel 10f, a scanner 10g, a printer 10h, a communication interface 10j and fingerprint readers 10kA, 10kB.

The scanner 10g is a device that optically reads images such as photos, letters/characters, drawings and graphs/charts present in the original document and generates image data.

The printer 10h prints images onto paper in accordance with user instructions based on the image data read by the scanner 10g or sent from the terminal device 2 or the like.

The communication interface 10j comprises a NIC (Network Interface Card) or modem and enables communication with other devices.

The control circuit 10e is a circuit to control such devices as the hard disk 10d, scanner 10g, printer 10h, communication interface 10j, operation panel 10f and fingerprint readers 10kA, 10kB.

The operation panel 10f comprises a display TD and an operation button unit SB having a plurality of operation buttons as shown in FIG. 3.

The operation button unit SB comprises a plurality of input buttons SB1 that enable input of numbers, letters/characters or other symbols, an input confirmation button SB2 that enables confirmation of the contents of user input performed using the input button SB1 or the display TD, a sensor that recognizes the pressing of the input button SB1 or the input confirmation button SB2, a transmission circuit that transmits signals indicating the recognized input button SB1 or input confirmation button SB2 to the CPU 10a, and the like. In order to permit reading of the user's fingerprint by the fingerprint reader 10kA described below, the surface of the input confirmation button SB2 comprises flat glass that is transparent to light of the wavelength emitted by the light source of the fingerprint reader 10kA.

The display TD is a touch panel display that displays such screens as a screen to provide messages or instructions to the user operating this image forming apparatus 1, a screen using which the user inputs desired types of processing and processing parameter values, a screen that displays images formed by the image forming apparatus 1, the results of operations or processes or the like. It also detects the position on the display touched by the user and sends to the CPU 10a a signal indicating the result of such detection.

In the example shown in FIG. 3, a plurality of input buttons SC1 having such button names as ‘Normal paper’, ‘One-sided paper’ and ‘Auto-detect’ are displayed on the display TD, and when the user presses one of the input buttons SC1, the display TD detects the position on the display TD pressed by the user and transmits to the CPU 10a a signal indicating which of the input buttons SC1 was pressed. In the example of FIG. 3, the input confirmation button SC2 having the button name ‘OK’ is displayed on the display TD. This input confirmation button SC2, like the input confirmation button SB2, is a button used to confirm the contents of information input via user operation of the input button SB1 or SC1. In addition, a flat glass panel that is transparent to light having the wavelength emitted by the light source of the fingerprint reader 10kB is used on the display screen of the display TD for reading of the user's fingerprint by the fingerprint reader 10kB described below.

The user inputs into the image forming apparatus 1 information specifying the type of processing desired or applicable parameter values by operating the input button SB1 or SC1. For example, the buttons may be used to execute a print or other job, view information stored in the image forming apparatus 1, change screens on the display TD or change various configuration settings.

If there is no error in the contents of the input information, the information is confirmed by making selection using the input confirmation button SB2 or SC2. When this is done, the CPU 10a controls the various components of the image forming apparatus 1 to execute processing in accordance with the confirmed contents.

As described above, the operation panel 10f fulfills the role of a user interface for a user who directly operates the image forming apparatus 1.

The fingerprint reader 10kA comprises such components as a light source 10k1, an optical system 10k2 and an imaging element 10k3, as shown in FIG. 4. The light source 10k1 is an LED (Light-Emitting Diode), and emits light toward the fingerprint of the finger of a user who presses the surface of the input confirmation button SB2. The optical system 10k2 comprises a lens, an aperture and mirrors, for example. The various components of the optical system 10k2 are disposed such that the light emitted from the light source 10k1 strikes the finger of a user who presses the surface of the input confirmation button SB2 and the reflected light reaches the imaging element 10k3 and forms an image of the fingerprint thereon. The imaging element 10k3 is an image sensor such as a CCD (Charge-Coupled Device) or CMOS (Complementary Metal Oxide Semiconductor), and generates fingerprint image data by converting the formed fingerprint image into electrical signals. The fingerprint reader 10kA reads the fingerprint of a user who presses the input confirmation button SB2 in this way.

The fingerprint reader 10kB has the same configuration as the fingerprint reader 10kA, and reads the fingerprint of a user who presses the input confirmation button SC2. In place of the optical system-based fingerprint reader shown in FIG. 4, this fingerprint reader may be based on a semiconductor or on pressure-sensitivity or heat-sensitivity.

The fingerprint readers 10kA, 10kB are used in order to prevent unauthorized persons from using the image forming apparatus 1 without permission even if the user who is logged in to the image forming apparatus 1 is away from the location of the image forming apparatus 1. These fingerprint readers 10kA, 10kB may be collectively termed the ‘fingerprint reader 10k’ herein.

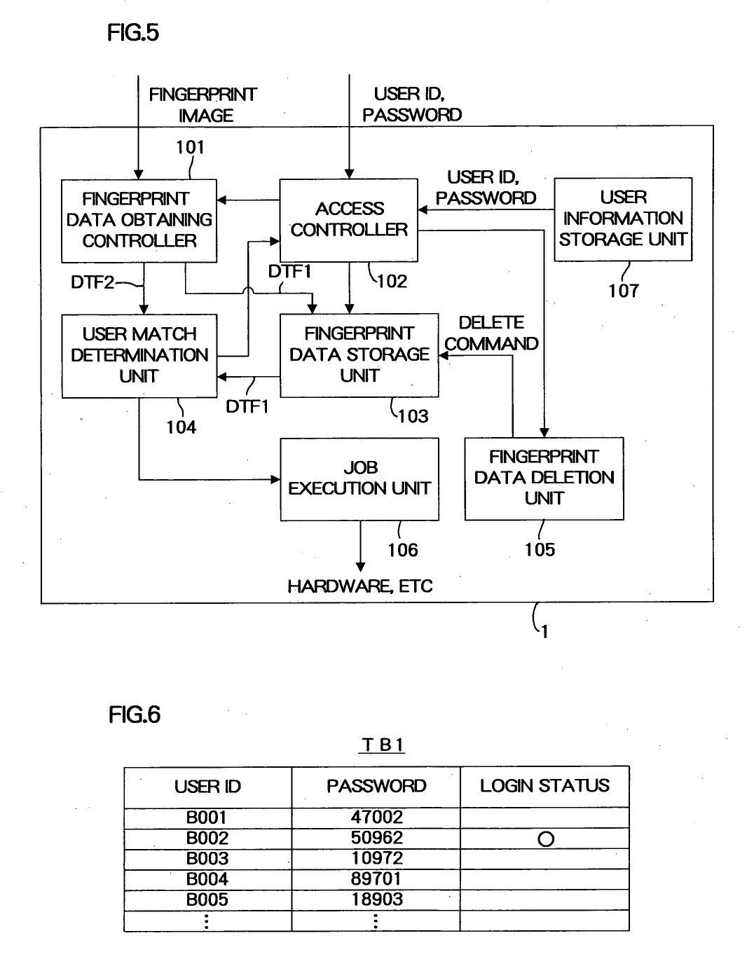

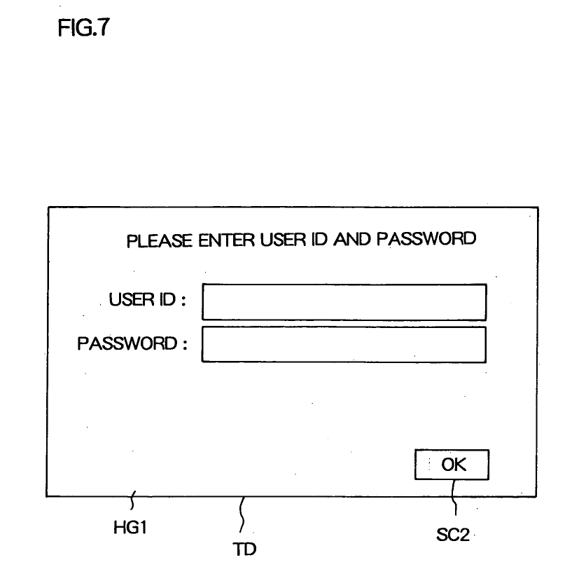

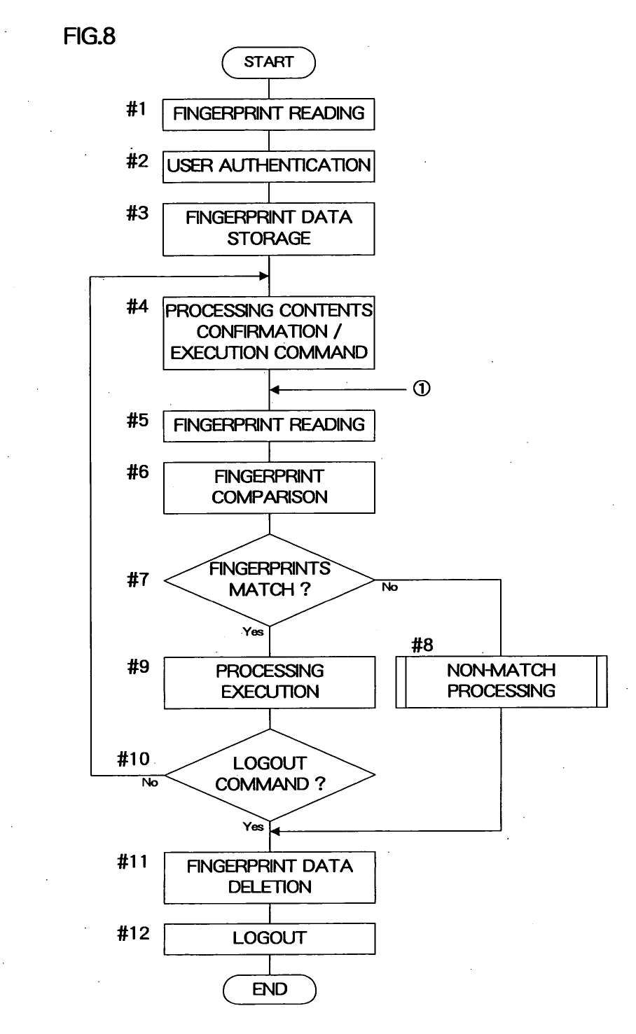

FIG. 5 is a drawing showing an example of the functional configuration of the image forming apparatus 1. FIG. 6 is a drawing showing an example of a user information table TB1. FIG. 7 is a drawing showing an example of a login screen HG1.

The hard disk 10d in FIG. 2 stores, among other things, programs and data used to execute the various functions of a fingerprint data obtaining controller 101, an access controller 102, a fingerprint data storage unit 103, a user match determination unit 104, a fingerprint data deletion unit 105, a job execution unit 106 and a user information storage unit 107, as shown in FIG. 5. These programs are read into the RAM 10b where necessary and are executed by the CPU 10a. All or part of these programs and data may be stored in the ROM 10c. Alternatively, all or part of the functions shown in FIG. 5 may be realized through a control circuit 10e.

The user information storage unit 107 stores and manages the user information table TB1 shown in FIG. 6. Stored in the user information table TB1 is data indicating the user ID, password and login status of each user. A user pertaining to a record for which the flag in the ‘login status’ field is up, i.e., a record for which the ‘login status’ value is ‘0’, is a user that is logged into the image forming apparatus 1. In the example shown in FIG. 6, the user having a user ID of ‘B002’ is logged in to the image forming apparatus 1. The ‘login status’ value is updated as appropriate when the user logs into or out of the image forming apparatus 1.

When no user is logged in, the login screen HG1 shown in FIG. 7 is displayed on the display TD. In order for a user to log into the image forming apparatus 1, the user enters his user ID and password via this login screen HG1 and presses the input confirmation button SC2 or the input confirmation button SB2 (see FIG. 3) to confirm the contents of the input information.

When this is done, the access controller 102 determines based on the confirmed user ID and password and the data in the user information table TB1 whether or not the user who made the input is an authorized user. If the user is recognized as an authorized user, that user is logged into the image forming apparatus 1. From that moment until the user logs out, the user can use the image forming apparatus 1. The access controller 102 executes logout processing described below.

During login processing, first, the password corresponding to the input-confirmed user ID is read out from the user information table TB1. If the read-out password matches the input-confirmed password, the image forming apparatus 1 confirms that the current user is an authorized user and permits the user to log into the image forming apparatus 1. A flag is then raised in the login status field of the record for that user ID in the user information table TB1. In this embodiment, the user authentication method comprises the memory-based authentication method based on a user ID and password but may comprise an ownership authentication method or other method.

The fingerprint data obtaining controller 101 carries out processing to obtain fingerprint data DTF indicating information pertaining to the fingerprint of the user operating the operation panel 10f. This processing is executed according to the following sequence, for example. In FIG. 4, when the fingerprint data obtaining controller 101 detects the pressing of the input confirmation button SB2 (as indicated by the encircled number ‘1’ in the drawing), it commands the fingerprint reader 10kA to read the fingerprint of the finger that pressed the input confirmation button SB2. When this is done, the light source 10k1 of the fingerprint reader 10kA emits light toward the input confirmation button SB2 (encircled numbers ‘3’ and ‘4’). This light reflects off of the finger pressed against the input confirmation button SB2 and is received by the imaging element 10k3 (encircled numbers ‘5’ and ‘6’). When this occurs, an image of the fingerprint is formed on the imaging element 10k3. The imaging element 10k3 generates fingerprint image data by converting the image into electrical signals and transmits this image data to the fingerprint data obtaining controller 101 (encircled number ‘7’). In FIG. 4, the chain-dot line indicates the movement of the signals, while the dashed line indicates the movement of the light.

Where the user presses the input confirmation button SC2, user fingerprint image data is generated by the fingerprint reader 10kB and is sent to the fingerprint data obtaining controller 101. The sequence of operations for fingerprint reading in this case is identical to the sequence followed by the fingerprint reader 10kA. In this way, the input confirmation buttons SB2, SC2 are used not only to confirm the contents of input information, but also as imaging instruction means during fingerprint imaging.

The fingerprint data obtaining controller 101 obtains the image data sent from the fingerprint reader 10kA or the fingerprint reader 10kB as fingerprint data DTF for the user operating the operation panel 10f. Here, the image data for the fingerprint image may itself be used as the fingerprint data DTF, or information pertaining to a specific characteristic point on the fingerprint (i.e., the position, orientation, type or other aspect of the characteristic point) may be extracted from the fingerprint image and this information may be used as the fingerprint data DTF.

When the user inputs a user ID or other information from the login screen HG1 and presses the input confirmation button SB2 or SC2 in order to confirm the contents of the input information, the fingerprint data storage unit 103 stores the fingerprint data DTF obtained by the fingerprint data obtaining controller 101 until a command to delete this information is issued by the access controller 102.

When user login to the image forming apparatus 1 is completed, a screen to specify the type of processing, applicable parameter values or the like is displayed on the display TD. Here, the user enters the contents of the processing that he wants the image forming apparatus 1 to execute by operating the input buttons SB1 or SC1 of the operation panel 10f. When input is completed, the user presses the input confirmation button SB2 or SC2 to confirm the contents of the input information. This causes a command for the execution of processing to be issued by the user to the image forming apparatus 1. In this case as well, the fingerprint data DTF for the finger pressed against the input confirmation button SB2 or SC2 is obtained by the fingerprint data obtaining controller 101. The fingerprint data DTF obtained at the time of confirmation of the contents of the processing (i.e., at the time the command to execute such processing is issued) is stored temporarily in the RAM 10b or the like without being saved in the fingerprint data storage unit 103. After such data is used for processing by the user match determination unit 104 described below, it is immediately deleted. In the discussion below, the fingerprint data DTF stored in the fingerprint data storage unit 103 at the time of login may be referred to as the ‘login fingerprint data DTF 1’, while the fingerprint data DTF stored in the RAM 10b or the like when a processing command is issued may be referred to as the ‘processing command fingerprint data DTF2’.

When a command to execute processing is issued by a user, the user match determination unit 104 calls out the login fingerprint data DTF1 from the fingerprint data storage unit 103 and determines, based on the processing command fingerprint data DTF2 obtained at the time such command was issued and the called-out login fingerprint data DTF1, whether or not the user who issued the processing command is the logged-in user. For example, it determines that there is a match if the degree of similarity between the characteristic point indicated by the login fingerprint data DTF1 and the characteristic point indicated by the processing command fingerprint data DTF2 equals or exceeds a threshold value a, and determines that there is no match if such degree of similarity does not reach the threshold value a.

Where a match is determined to exist, the job execution unit 106 is notified of such determination, while if a match is determined not to exist, the access controller 102 is notified of such determination.

When notification of a match is received, the job execution unit 106 controls the various components of the image forming apparatus 1 such that processing is executed in accordance with the processing contents input by the user, as in the prior art.

When notification of the absence of a match is received, the access controller 102 logs out the currently logged-in user and notifies the fingerprint data deletion unit 105 that logout has occurred. The user is also logged out and logout notification is issued where the user logs out on his own or where a prescribed period of time elapses without operation of the image forming apparatus 1.

When logout notification is received from the access controller 102, the fingerprint data deletion unit 105 deletes the login fingerprint data DTF1 stored in the fingerprint data storage unit 103.

The entire sequence of operations executed by the image forming apparatus 1 between user login and logout will now be described with reference to a flow chart.

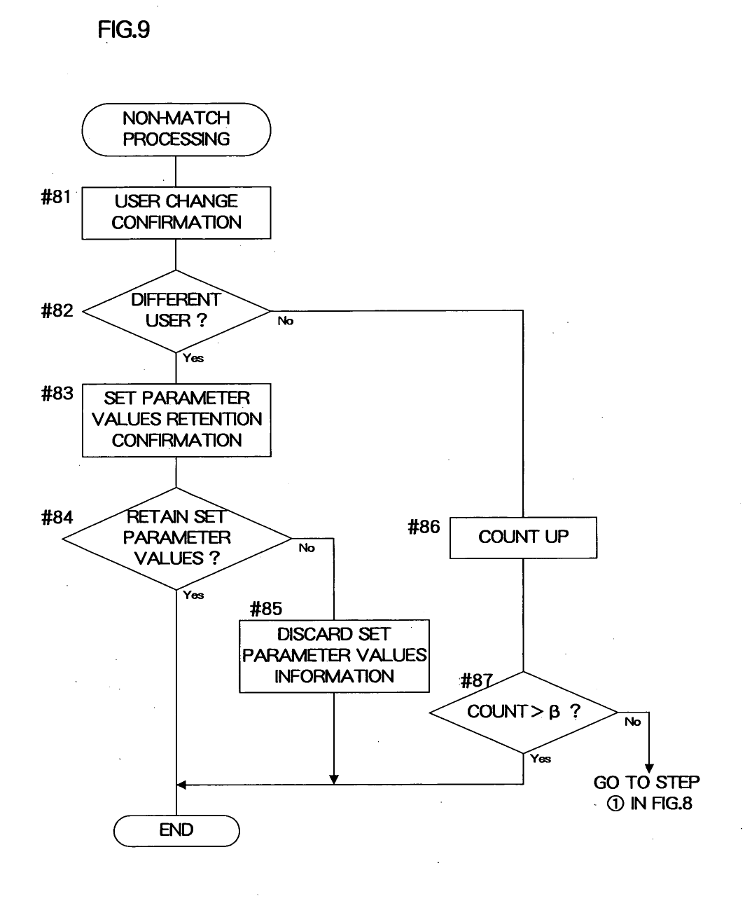

FIG. 8 is a flow chart pertaining to the entire series of operations executed by the image forming apparatus 1, while FIG. 9 is a flow chart pertaining to ‘no-match’ processing. The processes represented in these flow charts are controlled by the CPU 10a.

When no one is logged into the image forming apparatus 1, the login screen HG1 is displayed on the display TD. When a user wishing to use the image forming apparatus 1 inputs his user ID and password via the login screen HG1 and presses the input confirmation button SB2 or SC2, the image forming apparatus 1 reads the fingerprint image for the finger that pressed the input confirmation button SB2 or SC2 and obtains login fingerprint data DTF1 (#1), and executes the user authentication process (#2). If the user is recognized as an authorized user as a result of the user authentication process, the user is logged in. If the user is not recognized, a message indicating login denial is displayed on the display TD and the user is barred from using the image forming apparatus 1.

When login is completed, the image forming apparatus 1 saves the login fingerprint data DTF1 obtained in step #1 (#3).

The user for whom login is confirmed then inputs the contents of the desired processing using the input buttons SB1 or SC1. When input is completed, the user presses the input confirmation button SB2 or SC2 with the same finger used for login in order to confirm the input processing contents and enable the image forming apparatus 1 to execute such processing (#4).

When this is done, the image forming apparatus 1 reads the fingerprint of the finger that pressed the input confirmation button SB2 or SC2 and obtains the processing command fingerprint data DTF2 (#5). By comparing the fingerprint information indicated by the recently obtained processing command fingerprint data DTF2 with the login fingerprint data DTF1 stored in step #3, the image forming apparatus 1 then determines whether or not the logged-in user is the same person as the user who specified the processing contents (i.e., the user who issued the processing execution command) (#6). In other words, if the degree of similarity between the two fingerprint data sets equals or exceeds a threshold value a, the image forming apparatus 1 determines that the users are the same person, while if the degree of similarity does not reach the threshold value a, the image forming apparatus 1 determines that the users are different persons.

If the two users are determined to be identical (YES in #7), processing is executed based on the user-input processing contents in the same manner as in the prior art (#9). If the user then logs out after the execution of processing (YES in #10), the login fingerprint data DTF1 stored in step #3 is deleted and the currently logged-in user is logged out (#12). Where the logout operation is not performed (NO in #10), the operations including and subsequent to step #4 are repeated each time a processing execution command is issued by the user.

If it is determined in step #7 that the two users are different persons, however (NO in step #7), the issued processing command is denied. The login fingerprint data DTF1 stored in step #3 is then deleted (#11) and the currently logged-in user is logged out (#12).

Incidentally, it may occur that while the currently logged-in user is away from the image forming apparatus 1, another user operates the image forming apparatus 1 to issue a processing command without knowing that the first user is already logged into the image forming apparatus 1. However, in this case, because the fingerprint of the currently logged-in user naturally does not match the fingerprint of the other user, the issued processing command is denied. When this occurs, the other user must naturally re-perform from the start the operations necessary to issue the processing command after logging in once more to the image forming apparatus 1, which is burdensome. In addition, there may be cases where a user match may be determined not to exist due to problems with the reading of a fingerprint. When immediate logout occurs in this instance, the user also must log in once more and perform the necessary operations, which is burdensome.

Accordingly, a construction may be adopted wherein if the users are determined to be different persons (NO in #7), no-match processing is executed (#8), the login fingerprint data DTF1 is deleted and logout is performed where necessary. The no-match processing is carried out via the sequence of operations shown in FIG. 9.

A message prompting the user to answer the question of whether or not the user currently operating the image forming apparatus 1 is different from the logged-in user is displayed on the display TD (#81).

If an answer indicating that the users are different persons is returned (YES in #82), a message prompting the user to answer the question of whether or not the set parameter values input via the input button SB1 or SC1, such as the paper size and the magnification, should be retained is displayed on the display TD (#83).

If an answer indicating that the set parameter values should be retained is returned (YES in #84), the set parameter values information indicating those set parameter values is stored in the RAM 10b or the like. Proceeding to step #11 in FIG. 8, the login fingerprint data DTF1 for the currently logged-in user is deleted (#11) and that user is logged out from the image forming apparatus 1 (#12). As a result, the other user who operated the image forming apparatus 1 without the knowledge of the currently logged-in user can log into and use the image forming apparatus 1. In addition, after login, a screen that reproduces the parameter values previously set by the other user is displayed based on the set parameter values information stored in the RAM 10b.

If an answer indicating that the users are not different persons (i.e., that they are the same person) is returned, on the other hand (NO in #82), the CPU 10a returns to step #5 in FIG. 8 and retries fingerprint reading. However, the number of retries is counted (#86), and if the number of retries has exceeded a prescribed number (YES in #87), because this may indicate that a different person is improperly attempting to use the image forming apparatus 1, subsequent retry attempts are denied and the currently logged-in user is logged out from the image forming apparatus 1 (#12). When this occurs, the login fingerprint data DTF1 is also deleted (#11).

According to this embodiment, when a user logs into the image forming apparatus 1, information regarding the fingerprint of the user performing the login operation is obtained. Furthermore, when a processing command is issued, information regarding the fingerprint of the user performing the command issuance operation is obtained. The information regarding these two fingerprints is compared, and if it is determined that the currently logged-in user is the same user who issued the processing command, the processing related to that command is executed. In this way, even if a logged-in user leaves the image forming apparatus 1 without logging out, unauthorized use of the image forming apparatus 1 by a different person can be prevented. In other words, a scheme whereby the image forming apparatus 1 can be continuously used by only the logged-in and authenticated user can be provided, enabling security to be improved.

The login fingerprint data DTF1 stored in the fingerprint data storage unit 103 is saved only for the period of time that the user is logged in. The processing command fingerprint data DTF2 obtained upon the issuance of a processing command is deleted immediately after it is used to determine whether or not a user match exists. Therefore, because there is less danger than exists in the prior art of unauthorized disclosure of the login fingerprint data DTF1 and the processing command fingerprint data DTF2, which comprise sensitive personal information, the user can permit his fingerprint to be read by the image forming apparatus 1 without security concerns.

Fingerprint-based authentication in this embodiment is carried out in order to confirm whether or not a user seeking to carry out processing is the same person as the currently logged-in user. User authentication to determine whether or not the user using the image forming apparatus 1 is an authorized user is already complete at the time of login. Therefore, the threshold value a pertaining to the degree of matching, which is employed at the time of fingerprint verification, can be set to a value lower than that used for normal user authentication, thereby allowing user authentication to be performed more easily.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

The descriptions of this embodiment used an image forming apparatus such as an MFP as an example, but the present invention may be applied in a different type of processing apparatus such as a personal computer or a workstation that can be used by a plurality of users. In this case, a fingerprint reader may be connected to the apparatus via a USB or other connection and this fingerprint reader may be used as an input confirmation button. Alternatively, the fingerprint reader may be disposed in a mouse button.

In the above embodiment, while the risk of unauthorized outside disclosure of fingerprint information, which is sensitive personal information, is reduced by the fact that the user fingerprint information obtained at the time of login is deleted upon logout, thereby giving the user peace of mind, there may be cases in which, depending on the environment in which the image forming apparatus 1 is used or the purpose of use, a more secure user authentication process is desired. In this case, user authentication may be carried out via fingerprint verification. To accomplish this, fingerprint information for each user is registered in a database in advance. User authentication is carried out by comparing the user fingerprint information obtained at the time of login with the fingerprint information registered in the database. Furthermore, it is acceptable if the fingerprint information obtained at the time of execution of user-specified processing is compared with the fingerprint information for the currently logged-in user among all logged-in users registered in the database, or with the fingerprint information obtained at the time of login.

All or part of the configuration of the image forming apparatus 1, the processing contents, the sequence of operations, the table contents, the user authentication method or the like may be changed within the essential scope of the invention.

What is claimed is:

1. A processing apparatus comprising:
an input button used to input information;
an input confirmation button used to confirm the contents of said input information;
a first obtaining unit that obtains at the time of the user's login to said processing apparatus first fingerprint information comprising information regarding the user's fingerprint;
a storage device that stores said first fingerprint information obtained by said first obtaining unit;
a second obtaining unit that obtains second fingerprint information comprising information regarding the fingerprint of the finger used to press said input confirmation button;
a determination unit that, after the user has logged into said processing apparatus, determines whether or not the user who pressed said input confirmation button to confirm the contents of said input information is identical to the user who logged into said processing apparatus, by comparing (i) said second fingerprint information obtained by said second obtaining unit when said input confirmation button was pressed in order to confirm the contents of said information input via said input button and (ii) said first fingerprint information stored in said storage device; and
a controller that, when the user's identity is confirmed by said determination unit, executes control of the various components of said processing apparatus to carry out processing based on the contents of said input and confirmed information.

2. The processing apparatus according to claim 1, wherein there are a plurality of input confirmation buttons and said second obtaining unit obtains said second fingerprint information by reading the fingerprint of the finger used to press one of said input confirmation buttons.

3. The processing apparatus according to claim 1, wherein said first obtaining unit obtains said first fingerprint information by reading the fingerprint of the finger used to press said input confirmation button at the time of user login to said processing apparatus.

4. The processing apparatus according to claim 1, further comprising a deleting unit that deletes said user's first fingerprint information stored in said storage device at the time of user logout from said processing apparatus.

5. The processing apparatus according to claim 1, further comprising a logout processing unit that logs out the user from said processing apparatus when said determination unit determines that the user who pressed said input confirmation button is not identical to the user who logged into said processing apparatus.

6. A control method for a processing apparatus including an input button used to input information, an input confirmation button used to confirm the contents of said input information and a reading unit that reads a fingerprint of a finger used to press said input confirmation button, said method comprising the steps of:
1) obtaining first fingerprint information comprising information regarding the user's fingerprint at the time of the user's login to said processing apparatus;
2) storing said first fingerprint information obtained in said step 1 in a storage device;
3) reading the fingerprint of a finger used to press said input confirmation button to confirm the contents of said information input via said input button by said reading unit;
4) determining whether or not the user who pressed said input confirmation button to confirm the contents of said input information is identical to the user who logged into said processing apparatus, by comparing (i) said second fingerprint information comprising information regarding the fingerprint obtained in said step 3 and (ii) said first fingerprint information stored in said storage device; and
5) if the user who logged into said processing apparatus and the user who pressed said input confirmation button in order to confirm the contents of said input information are determined to be identical, executing processing based on the contents of said input and confirmed information.

7. The control method according to claim 6, wherein in said step 1, said first fingerprint information is obtained by having said reading unit read the fingerprint of the finger used to press said input confirmation button at the time of user login to said processing apparatus.

8. The control method according to claim 6, further comprising a step of deleting said user's first fingerprint information stored in said storage device at the time of user logout from said processing apparatus.

9. The control method according to claim 6, further comprising a step of logging out the user from said processing apparatus when it is determined in said step 4 that the user who pressed said input confirmation button is not identical to the user who logged into said processing apparatus.

10. A computer readable recording medium stored therein a computer program used to control a processing apparatus that includes an input button used to input information, an input confirmation button used to confirm the contents of said input information and a reading unit that reads a fingerprint of a finger used to press said input confirmation button, said computer program causing said processing apparatus to execute processing comprising the steps of:
1) obtaining first fingerprint information comprising information regarding the user's fingerprint at the time of the user's login to said processing apparatus;
2) storing said first fingerprint information obtained in said step 1 in a storage device;
3) reading the fingerprint of a finger used to press said input confirmation button to confirm the contents of said information input via said input button by said reading unit;
4) determining whether or not the user who pressed said input confirmation button to confirm the contents of said input information is identical to the user who logged into said processing apparatus, by comparing (i) said second fingerprint information comprising information regarding the fingerprint obtained in said step 3 and (ii) said first fingerprint information stored in said storage device; and
5) if the user who logged into said processing apparatus and the user who pressed said input confirmation button in order to confirm the contents of said input information are determined to be identical, executing processing based on the contents of said input and confirmed information.

11. The recording medium according to claim 10, wherein in said step 1, said first fingerprint information is obtained by having said reading unit read the fingerprint of the finger used to press said input confirmation button at the time of user login to said processing apparatus.

12. The recording medium according to claim 10, wherein said processing further comprises a step of deleting said user's first fingerprint information stored in said storage device at the time of user logout from said processing apparatus.

13. The recording medium according to claim 10, wherein said processing further comprises a step of logging out the user from said processing apparatus when it is determined in said step 4 that the user who pressed said input confirmation button is not identical to the user who logged into said processing apparatus.
